(19) United States
(12) Patent Application Publication
(10) Pub. No.: US 2020/0153637 A1
(43) Pub. Date: May 14, 2020

(54) INFORMATION PROCESSING SYSTEM, METHOD FOR PROVIDING DATA, AND METHOD FOR BUILDING INFORMATION PROCESSING SYSTEM

(71) Applicant: TOHOKU UNIVERSITY, Sendai-shi (JP)

(72) Inventors: Masao SAKAI, Sendai-shi (JP); Junya IWAZAKI, Sendai-shi (JP); Eisuke KOIZUMI, Sendai-shi (JP); Shingo HASEGAWA, Sendai-shi (JP); Shuji ISOBE, Sendai-shi (JP); Masayuki FUKUMITSU, Ebetsu-shi (JP)

(21) Appl. No.: 16/674,379

(22) Filed: Nov. 5, 2019

(30) Foreign Application Priority Data
Nov. 9, 2018 (JP) JP2018-211813

(51) Int. Cl. H04L 9/32; G06Q 20/40; G06Q 20/38

(52) U.S. Cl. CPC H04L 9/3247; G06Q 20/40; G06Q 20/3825; H04L 2209/38; H04L 9/3236; H04L 2209/56; G06Q 20/3821

(57) ABSTRACT

An information processing system 100 includes a first node 1 that stores data; a second node 2 that receives the data from the first node 1; at least one storage node 3; and a blockchain 4. The first node 1 includes a first identification information generation unit 152, a template acquisition unit 153, a contract document preparation unit 154, a contract document release unit 155, and a storage request unit 156, wherein a template is provided with an address area in which a data-receiving address of a node that wishes to obtain the data is entered. The second node 2 includes a contract document selection unit 251, an address entry unit 252, a signature unit 253, and a registration unit 254. The at least one storage node 3 includes a storage execution unit 353, a contract completion determination unit 354, and a data transmission unit 355.

### TECHNICAL FIELD

The present invention relates to an information processing system for safely and quickly executing a smart contract on confidential information; a method for providing data; and a method for building the information processing system.

### BACKGROUND ART

A smart contract is a transaction (contract) automatically executed by collaborative processing operations by many unspecified nodes, without relying on a centralized management server. After the success of Bitcoin, smart contracts have attracted attention as an application of blockchain technology, which is the core technology of Bitcoin.

In a smart contract for buying and selling valuable product data, such as movie or music content, or personal information (e.g., medical images), the contract details are recorded in a blockchain, and the contract is then completed; after that (i.e., after completion of the payment from the buyer to the seller), the buyer must receive the product data from the seller in some manner. There are two main technologies that can perform this.

The first technique is a method in which the seller directly transmits confidential information to the buyer (e.g., NPL 1). In this method, the buyer cannot receive confidential information unless the seller is online. More specifically, a general user who may go offline frequently for a long period of time cannot participate in such a smart contract as a seller.

The second technology is a method in which the seller saves confidential information in some online storage, and records its storage location in the contract details; and the buyer downloads the information from the storage location after the contract has been completed (e.g., NPL 2 and 3). This method enables the seller to immediately receive the confidential information, even when the seller goes offline frequently and for a long period of time. However, this method records the storage location of confidential information in a blockchain, and releases the information to all users. Thus, even if the storage destination is set to deny access from a party other than the buyer, confidential information may be revealed to someone other than the buyer when a powerful hacking attack has occurred.

### CITATION LIST

### Non-Patent Literature

NPL 1: Masayuki FUKUMITSU et al. (8 authors in total), A Method for a Practical Smart Contract by using Blockchain and Centralized Server, Information Processing Society of Japan Technical Report, Jul. 25, 2018, Vol. 2018-CSEC-82, No. 8
NPL 2: “Kirari!” wo Sasaeru Kosei Gijutsu (Constructing Technique to Support “Kirari!”): Content Management Technique with Application of Blockchain, R&D Activity, February 2016, online (URL: http://www.ntt.co.jp/RD/active/201602/jp/pf/pf003.html)
NPL 3: Shigenori OHASHI, Smart Property no Gaiyo to Content Kanri eno Tekiyo (An Outline of Smart Property and Application of Smart Property to Content Management), NTT Service Evolution Laboratories, Apr. 26, 2016, online (URL: http://www.glocom.ac.jp/wp-content/uploads/2016/04/20160426BC1_mrohashi.pdf)

### SUMMARY OF INVENTION

### Technical Problem

The present invention was made to solve the problems described above; and an object of the invention is to provide a technique to safely and quickly execute a smart contract for providing data, even when the seller is offline.

### Solution to Problem

An information processing system according to the present invention is an information processing system comprising

a first node that stores data, a second node that receives the data from the first node, at least one storage node, and a database, wherein
the first node comprises
a first identification information generation unit that generates identification information of the data,
a template acquisition unit that acquires a template for a contract document for the first node to provide the data,
a contract document preparation unit that enters the identification information in the template and signs the template to prepare a contract document,
a contract document release unit that releases the contract document to the second node, and
a storage request unit that transmits the data to the at least one storage node and requests the at least one storage node to store the data,
wherein the template is provided with an address area in which a data-receiving address of a node that wishes to obtain the data is entered,
the second node comprises
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit,
the at least one storage node comprises
a second identification information generation unit that generates identification information of the data when the at least one storage node has received the request from the storage request unit,
a storage execution unit that stores the data together with the identification information,
a contract completion determination unit that searches whether the contract document that includes the identification information entered therein has been registered in the database to determine whether a contract in the contract document has been completed, and
a data transmission unit that transmits the stored data to the data-receiving address entered in the address area of the contract document when the contract is determined to have been completed.

An information processing system according to the present invention is an information processing system comprising
a first node that stores data, a second node that receives the data from the first node, at least one storage node, and a database, wherein
the first node comprises
a first identification information generation unit that generates identification information of the data,
a template acquisition unit that acquires a template for a contract document for the first node to provide the data,
a contract document preparation unit that enters the identification information in the template and signs the template to prepare a contract document,
a contract document release unit that releases the contract document to the second node, and
a storage request unit that transmits the data together with the identification information to the at least one storage node and requests the at least one storage node to store the data,
wherein the template is provided with an address area in which a data-receiving address of a node that wishes to obtain the data is entered,
the second node comprises
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit,
the at least one storage node comprises
a storage execution unit that stores the data together with the identification information when the at least one storage node has received the request from the storage request unit,
a contract completion determination unit that searches whether the contract document that includes the identification information entered therein has been registered in the database to determine whether a contract in the contract document has been completed, and
a data transmission unit that transmits the stored data to the data-receiving address entered in the address area of the contract document when the contract is determined to have been completed.

A method for providing data according to the present invention is a method for providing data from a first node to a second node in an information processing system that comprises the first node, the second node, at least one storage node, and a database, the method comprising
a first identification information generation step of generating identification information of the data in the first node,
a template acquisition step of acquiring in the first node a template for a contract document for the first node to provide the data, the template being provided with an address area in which a data-receiving address of a node that wishes to obtain the data is entered,
a contract document preparation step of entering the identification information in the template and signing the template in the first node to prepare a contract document,
a contract document release step of releasing the contract document to the second node,
a storage request step of transmitting the data from the first node to the at least one storage node and requesting the at least one storage node to store the data,
a second identification information generation step of generating identification information of the data when the at least one storage node has received the request of the storage request step,
a storage execution step of storing the data together with the identification information,
a contract completion determination step of searching whether the contract document that includes the identification information entered therein has been registered in the database to determine whether a contract in the contract document has been completed in the at least one storage node,
a contract document selection step of selecting the released contract document in the second node,
an address entry step of entering a data-receiving address of the second node in the address area of the selected contract document in the second node,
a signature step of signing the selected contract document in the second node,
a registration step of registering in the database the contract document that includes the data-receiving address entered in the address entry step and a signature placed in the signature step, and
a data transmission step of transmitting the stored data in the at least one storage node to the data-receiving address that has been entered in the address area of the contract document when the contract is determined to have been completed in the contract completion determination step.

A method for providing data according to the present invention is a method for providing data from a first node to a second node in an information processing system that comprises the first node, the second node, at least one storage node, and a database, the method comprising
a first identification information generation step of generating identification information of the data in the first node,
a template acquisition step of acquiring in the first node a template for a contract document for the first node to provide the data, the template being provided with an address area in which a data-receiving address of a node that wishes to obtain the data is entered,
a contract document preparation step of entering the identification information in the template and signing the template in the first node to prepare a contract document,
a contract document release step of releasing the contract document to the second node,
a storage request step of transmitting the data together with the identification information from the first node to the at least one storage node and requesting the at least one storage node to store the data,
a storage execution step of storing the data together with the identification information when the at least one storage node has received the request of the storage request step,
a contract completion determination step of searching whether the contract document that includes the identification information entered therein has been registered in the database to determine whether a contract in the contract document has been completed in the at least one storage node,
a contract document selection step of selecting the released contract document in the second node,
an address entry step of entering a data-receiving address of the second node in the address area of the selected contract document in the second node,
a signature step of signing the selected contract document in the second node,
a registration step of registering in the database the contract document that includes the data-receiving address entered in the address entry step and a signature placed in the signature step, and
a data transmission step of transmitting the stored data from the at least one storage node to the data-receiving address that has been entered in the address area of the contract document when the contract is determined to have been completed in the contract completion determination step.

A method for building an information processing system according to the present invention is a method for building an information processing system that comprises a first node that stores data, a second node that receives the data from the first node, at least one storage node, and a database, the method comprising
a step of delivering to the first node a program for causing a computer to operate as
a first identification information generation unit that generates identification information of the data,
a template acquisition unit that acquires a template for a contract document for the first node to provide the data, the template being provided with an address area in which a data-receiving address of a node that wishes to obtain the data is entered,
a contract document preparation unit that enters the identification information in the template and signs the template to prepare a contract document,
a contract document release unit that releases the contract document to the second node, and
a storage request unit that transmits the data to the at least one storage node and requests the at least one storage node to store the data,
a step of delivering to the second node a program for causing a computer to operate as
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit, and
a step of delivering to the at least one storage node a program for causing a computer to operate as
a second identification information generation unit that generates identification information of the data when having received the request from the storage request unit,
a storage execution unit that stores the data together with the identification information,
a contract completion determination unit that searches whether the contract document that includes the identification information entered therein has been registered in the database to determine whether a contract in the contract document has been completed, and
a data transmission unit that transmits the stored data to the data-receiving address entered in the address area of the contract document when the contract is determined to have been completed.

A method for building an information processing system according to the present invention is a method for building an information processing system that comprises a first node that stores data, a second node that receives the data from the first node, at least one storage node, and a database, the method comprising
a step of delivering to the first node a program for causing a computer to operate as
a first identification information generation unit that generates identification information of the data,
a template acquisition unit that acquires a template for a contract document for the first node to provide the data, the template being provided with an address area in which a data-receiving address of a node that wishes to obtain the data is entered,
a contract document preparation unit that enters the identification information in the template and signs the template to prepare a contract document,
a contract document release unit that releases the contract document to the second node, and
a storage request unit that transmits the data to the at least one storage node together with the identification information and requests the at least one storage node to store the data,
a step of delivering to the second node a program for causing a computer to operate as
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit, and
a step of delivering to the at least one storage node a program for causing a computer to operate as
a storage execution unit that stores the data together with the identification information when having received the request from the storage request unit,
a contract completion determination unit that searches whether the contract document that includes the identification information entered therein is registered in the database to determine whether a contract in the contract document has been completed, and
a data transmission unit that transmits the stored data to the data-receiving address entered in the address area of the contract document when the contract is determined to have been completed.

The database for use is preferably a blockchain.

### Advantageous Effects of Invention

In the present invention, data of the first node is temporarily stored in the at least one storage node, and transmitted from the at least one storage node to the second node. However, the storage location of the data is not recorded in the contract document; instead, the data-receiving address of the second node, which is the buyer, is recorded. When a contract has been completed, the data is transmitted from the at least one storage node to the data-receiving address recorded in the contract document. Thus, even when the first node 1, which is the seller of the data, is offline, the second node, which is the buyer, can receive the data promptly after the contract has been completed. Additionally, because the storage location (storage node) of the data is not recorded in the contract document registered in the database, hacking attacks against the at least one storage node by a third party can be avoided. Thus, even when the seller is offline, a smart contract for providing data can be executed safely and quickly.

### BRIEF DESCRIPTION OF DRAWINGS

FIG. 1 is a schematic view illustrating an information processing system according to the first embodiment.

FIG. 2 is a functional block diagram illustrating the configuration of the first node according to the first embodiment.

FIG. 3 is a functional block diagram illustrating the configuration of the second node according to the first embodiment.

FIG. 4 is a functional block diagram illustrating the configuration of the storage node according to the first embodiment.

FIG. 5 is a sequence chart illustrating the process of the method for providing data in the information processing system according to the first embodiment.

FIG. 6 illustrates an example of a template for the contract document according to the first embodiment.

FIG. 7 illustrates an example of the contract document prepared in the first node according to the first embodiment.

FIG. 8 illustrates an example of the contract document that includes a data-receiving address further entered in the address entry space, and an electronic signature of the buyer of data provided in the signature space.

FIG. 9 is a schematic view illustrating an information processing system according to the second embodiment.

FIG. 10 is a functional block diagram illustrating the configuration of the first node according to the second embodiment.

FIG. 11 is a functional block diagram illustrating the configuration of the second node according to the second embodiment.

FIG. 12 is a functional block diagram illustrating the configuration of the storage node according to the second embodiment.

FIG. 13 is a functional block diagram illustrating the configuration of the intermediary node according to the second embodiment.

FIG. 14 is a sequence chart illustrating the process of the method for providing data in the information processing system according to the second embodiment.

FIG. 15 is a sequence chart illustrating the process of the method for providing data in the information processing system according to the second embodiment.

FIG. 16 illustrates an example of a template for the contract document according to the second embodiment.

FIG. 17 illustrates an example of the contract document prepared in the first node according to the second embodiment.

FIG. 18 illustrates an example of the contract document that further includes an electronic signature of the intermediary agent provided in the signature space.

FIG. 19 illustrates an example of the contract document that further includes a data-receiving address entered in the address entry space and an electronic signature of the buyer of data provided in the signature space.

### DESCRIPTION OF EMBODIMENTS

The following describes embodiments of the present invention with reference to attached drawings. However, the present invention is not limited to the following embodiments.

### First Embodiment

First, for better understanding of the features of the present invention, a simplified embodiment is described as the first embodiment.

### Configuration of System

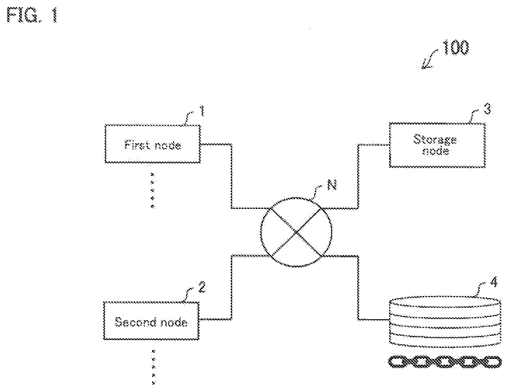

FIG. 1 schematically illustrates an information processing system 100 according to the first embodiment. The information processing system 100 is a platform using the blockchain technique, and includes a first node 1, a second node 2, a storage node 3, and a blockchain 4. The first node 1, the second node 2, the storage node 3, and the blockchain 4 are communicably connected to each other by wire or wirelessly, for example, via a communication network N, such as the internet.

The first node 1 stores data, which is confidential information, and is an information processing device managed by the seller who wishes to sell the data. In the first node 1, a first program P1, described later, is installed. The first node 1 may be composed of a general-purpose computer, such as a desktop PC, a laptop PC, a smartphone, a tablet terminal, or a PDA.

The second node 2 is an information processing device managed by the buyer who is to receive the data in the first node 1. In the second node 2, a second program P2, described later, is installed. The second node 2 may also be composed of a general-purpose computer, such as a desktop PC, a laptop PC, a smartphone, a tablet terminal, or a PDA, as with the first node 1.

The storage node 3 is an information processing device provided with an online storage for temporarily storing transferred data. In the storage node 3, a storage program, described later, is installed. The user of the storage node 3 is not particularly limited, and the storage node 3 may be a server managed by a vendor who provides an online storage service, or a terminal device managed by an individual. Alternatively, the storage node 3 may be those that constitute a P2P storage as in the second embodiment described later.

The blockchain 4 is formed as follows: information of transactions executed between all nodes existing in the information processing system 100 is consolidated at regular intervals, and blocked; evidence information indicating that each block satisfies conditions for consolidation with the previous block is recorded in each block, and then blocks are connected in a chain shape. The blockchain 4 contains the records of all previous transactions, and is managed by a group of nodes existing in the information processing system 100 in a decentralized manner. The information processing system 100 can also make a transaction via its own crypto currency. Examples of such a crypto currency include Bitcoin and Ethereum. In this embodiment, the crypto currency is assumed to be Bitcoin.

The information processing system 100 may include a node other than the first node 1, second node 2, and storage node 3; i.e., a node in which none of the first program, second program, and storage program are installed.

### Configuration of Each Node

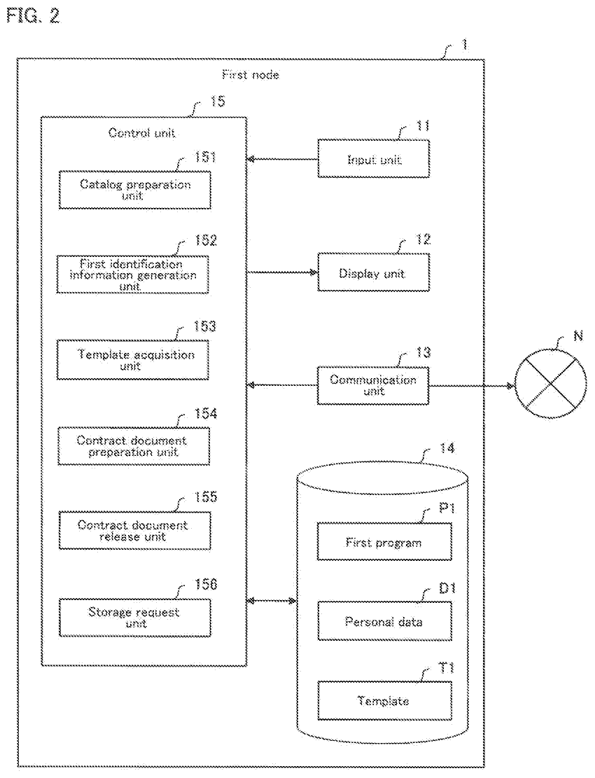

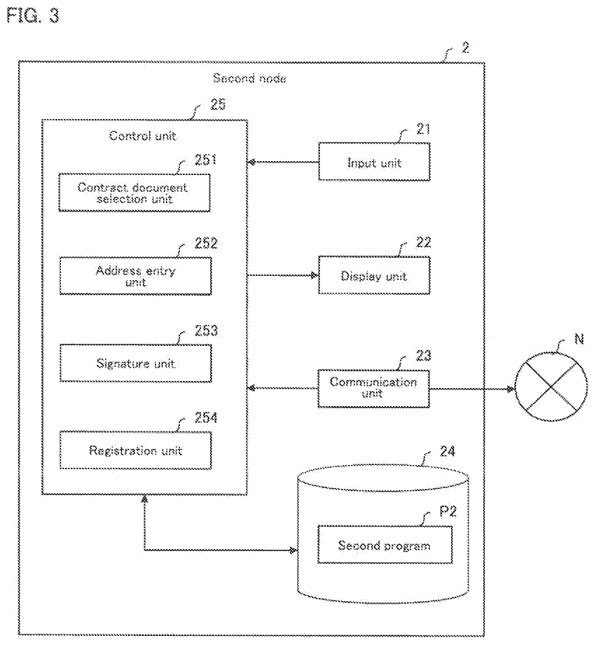

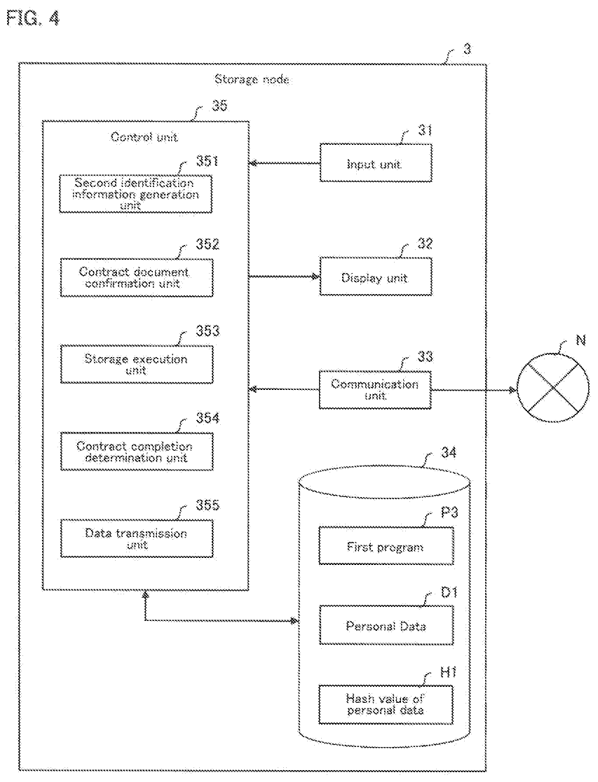

FIG. 2 is a functional block diagram illustrating the configuration of the first node 1. FIG. 3 is a functional block diagram illustrating the configuration of the second node 2. FIG. 4 is a functional block diagram illustrating the configuration of the storage node 3.

As shown in FIG. 2, the first node 1 includes an input unit 11, a display unit 12, a communication unit 13, a storage unit 14, and a control unit 15.

The input unit 11 may be composed of, for example, a keyboard, a mouse, or a touchscreen. The display unit 12 may be composed of, for example, a liquid crystal display or an organic EL display. The communication unit 13 is an interface that allows the first node 1 to communicate with, for example, other nodes via the communication network N.

The storage unit 14 is a nonvolatile auxiliary storage device for storing various types of programs and data used by the first node 1. The storage unit 14 may be composed of, for example, a hard disk drive (HDD) or a solid-state drive (SSD).

The storage unit 14 stores a first program P1, personal data D1, and a template T1 according to this embodiment. The first program P1 is a program for causing the first node 1 to execute a part of the processing steps of a service for enabling safe and quick execution of a smart contract in the information processing system 100 (“smart contract execution service”). The method for delivering the first program P1 to the first node 1 can be any method. The first program P1 may be downloaded to the first node 1 via the communication network N; or the first program P1 may be stored in a non-transitory computer-readable recording medium, and then installed in the first node 1 via the recording medium. For example, if a smartphone is used as the first node 1, the first program P1 can be delivered to the first node 1 via the App Store (registered trademark) of Apple Inc. or Google Play (registered trademark) of Google LLC.

The personal data D1 is confidential information that the user of the first node 1 wishes to sell. Examples of such confidential information include medical images of the user.

The template T1 is a template for a contract document for the first node to provide various types of data. The template T1 is stored in the storage unit 14 when the first node 1 has installed the first program P1. Examples of the template T1 will be described later.

The control unit 15 is a functional block that is put into practice when an arithmetic processing unit, such as a CPU or MPU, provided in the first node 1 retrieves the first program P1 stored in the storage unit 14 into a main storage device, such as RAM, and executes the first program P1. The control unit 15 includes a catalog preparation unit 151, a first identification information generation unit 152, a template acquisition unit 153, a contract document preparation unit 154, a contract document release unit 155, and a storage request unit 156. The function of these units will be described later.

As shown in FIG. 3, the second node 2 includes an input unit 21, a display unit 22, a communication unit 23, a storage unit 24, and a control unit 25. The input unit 21, the display unit 22, the communication unit 23, and the storage unit 24 may be respectively configured in the same manner as the input unit 11, the display unit 12, the communication unit 13, and the storage unit 14 of the first node 1.

The storage unit 24 stores a second program P2 according to this embodiment. The second program P2 is a program for causing the second node 2 to execute a part of the processing steps of a smart contract execution service. The method for delivering the second program P2 to the second node 2 can be any method. The second program P2 may be downloaded to the second node 2 via the communication network N; or the second program P2 may be stored in a non-transitory computer-readable recording medium, and then installed in the second node 2 via the recording medium.

The control unit 25 is a functional block that is put into practice when the arithmetic processing unit, such as a CPU or MPU, provided in the second node 2 retrieves the second program P2 stored in the storage unit 24 into a main storage device, such as RAM, and executes the second program P2. The control unit 25 includes a contract document selection unit 251, an address entry unit 252, a signature unit 253, and a registration unit 254. The function of these units will be described later.

As shown in FIG. 4, the storage node 3 includes an input unit 31, a display unit 32, a communication unit 33, a storage unit 34, and a control unit 35. The input unit 31, the display unit 32, the communication unit 33, and the storage unit 34 may be respectively configured in the same manner as the input unit 11, the display unit 12, the communication unit 13, and the storage unit 14 of the first node 1.

The storage unit 34 stores a storage program P3 according to this embodiment. The storage program P3 is a program for causing the storage node 3 to execute a part of the processing steps of a smart contract execution service. The method for delivering the storage program P3 to the storage node 3 can be any method. The storage program P3 may be downloaded to the storage node 3 via the communication network N; or the storage program P3 may be recorded in a non-transitory computer-readable recording medium, and then installed in the storage node 3 via the recording medium.

The control unit 35 is a functional block that is put into practice when the arithmetic processing unit, such as a CPU or MPU, provided in the storage node 3 retrieves the storage program P3 stored in the storage unit 34 into a main storage device, such as RAM, and executes the storage program P3. The control unit 35 includes a second identification information generation unit 351, a contract document confirmation unit 352, a storage execution unit 353, a contract completion determination unit 354, and a data transmission unit 355. The function of these units will be described later.

### Processing Procedure

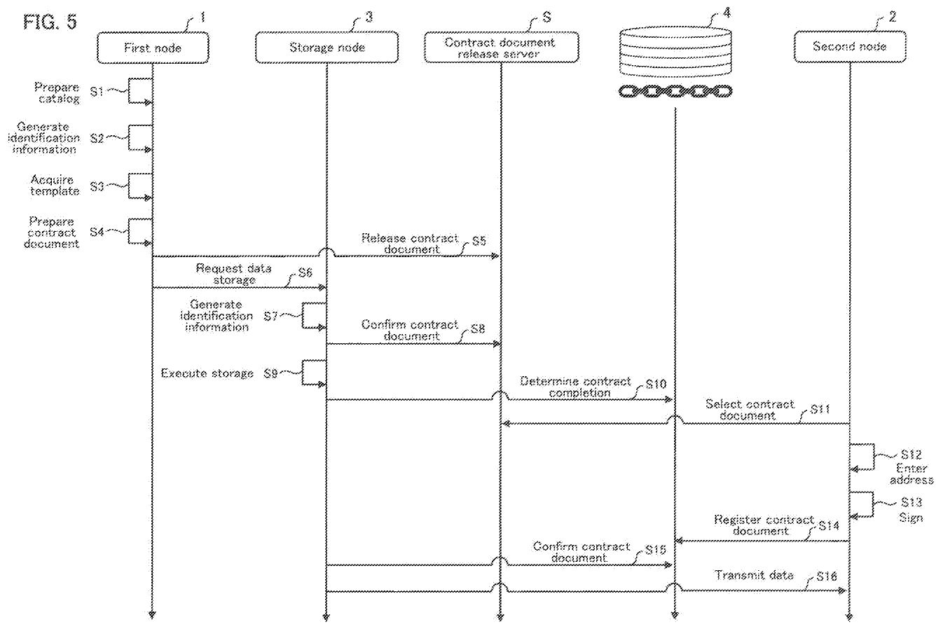

FIG. 5 is a sequence chart illustrating the processing steps of the method for providing data by which personal data is provided from the first node 1 to the second node 2 in the information processing system 100. The communication mode in each processing step can be any mode. The settlement operation using a crypto currency, or other operations performed in practice, are omitted in this embodiment for convenience.

In this embodiment, the control unit 15 in the first node 1, the control unit 25 in the second node 2, and the control unit 35 in the storage node 3, respectively illustrated in FIGS. 2 to 4, execute the main processing steps in FIG. 5. Alternatively, a user may manually execute a part of the processing steps in FIG. 5 via the input unit 11 in the first node 1, the input unit 21 in the second node 2, or the input unit 31 in the storage node 3.

First, in the first node 1, the catalog preparation unit 151 prepares a catalog for explaining the content of personal data D1, which is confidential information (step S1). If the personal data D1 is a medical image, the catalog contains, for example, the user's gender, height, weight, and medical history, the date and time of photographing, and the type of format.

Subsequently, the first identification information generation unit 152 in the first node 1 generates identification information for the personal data D1 (step S2, first identification information generation step). The specific content of identification information can be any content; in this embodiment, the first identification information generation unit 152 calculates a hash value of the personal data D1 (“Hash-D”), and determines the hash value (Hash-D) to be the identification information.

Subsequently, the template acquisition unit 153 in the first node 1 acquires a template T1 for a contract document for selling the personal data D1 (step S3, template acquisition step). In this embodiment, the template acquisition unit 153 retrieves the template T1 stored in the storage unit 14 into the main storage device to acquire the template T1. When the template T1 is not stored in the storage unit 14, the template acquisition unit 153 may download the template T1 from another node, or prepare the template T by user operation to acquire the template T1.

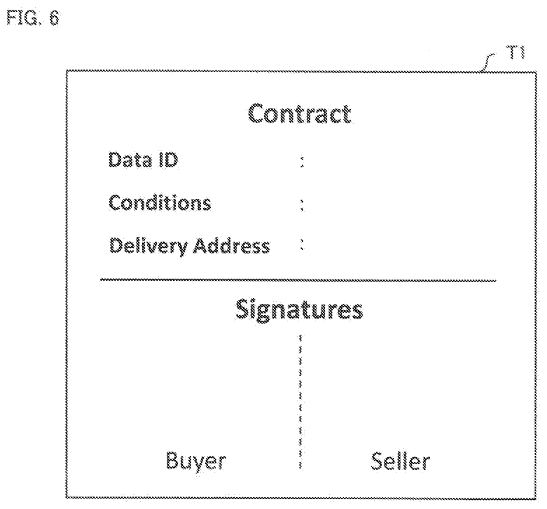

FIG. 6 is an example of the template T1. The template T1 is provided with a space in which identification information (Data ID), conditions under which data are provided (Conditions), and signatures (Signatures) are entered as in a typical contract document. The template T1 is further provided with an address area in which the data-receiving address (Delivery Address) of a node that wishes to obtain the data is entered.

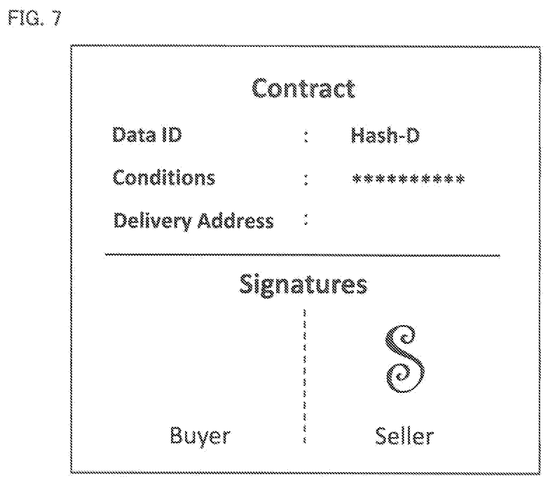

Refer back to FIG. 5. After completion of the acquisition of the template T1, the contract document preparation unit 154 in the first node 1 enters the identification information in the template T1 and signs the template T1, thereby preparing a contract document (step S4, contract document preparation step). FIG. 7 shows an example of a prepared contract document. As described above, because the identification information is a hash value of the personal data D1 (Hash-D), the Hash-D is entered as identification information. A condition, such as the offer price of data, is entered for the conditions. The electronic signature of the seller of data (Seller) is entered in the signature space.

The space for entering a data-receiving address in the contract document is for entering the address of the buyer of data (Buyer). Thus, the space is left blank at this stage.

Refer back to FIG. 5. After completion of the preparation of the contract document, the contract document release unit 155 in the first node 1 releases the contract document to the second node 2 (step S5, contract document release step). In this embodiment, the contract document release unit 155 uploads the contract document together with the catalog in a predetermined contract document release server S, thereby releasing the contract document to all nodes in the information processing system 100. The method for releasing the contract document to the second node 2 by the contract document release unit 155 can be any method. For example, the first node 1 may directly transmit the contract document to the second node 2 to offer the sale of the personal data D1. In this case, the contract document is not released to nodes other than the second node 2.

In the first node 1, the storage request unit 156 transmits the personal data D1 to the storage node 3, and requests the storage node 3 to store the personal data D1 (step S6, storage request step). The storage node 3 may be suitably selected by the first node 1, or may be a node designated by a vendor that offers the smart contract execution service. The request may contain access information for the contract document uploaded in step S5. In step S6, the storage request unit 156 may transmit the personal data D1 together with the identification information (a hash value (Hash-D)) to the storage node 3.

As described above, the initial steps S1 to S6 are performed in the first node 1.

Subsequently, when the storage node 3 has received the request from the storage request unit 156 in the first node 1, the second identification information generation unit 351 in the storage node 3 calculates the hash value of the personal data D1 (=Hash-D) as its identification information H1 (step S7). When the storage request unit 156 has transmitted the identification information together with the personal data D1 to the storage node 3 in step S6, step S7 may be skipped.

Additionally, the contract document confirmation unit 352 accesses the contract document uploaded in step S5. On the basis of the identification information H1, the contract document confirmation unit 352 confirms that the contract document that includes the identification information H1 entered therein is released (step S8). Step S8 may be skipped.

Thereafter, the storage execution unit 353 in the storage node 3 stores the personal data D1 and the identification information H1 in the storage unit 34 of the storage node 3 (step S9, storage execution step). The storage location of the personal data D1 and the identification information H1 can be any location. The storage location may be another storage communicable with the storage node 3. When the contract document is not released to the nodes other than the second node 2, step S9 may be performed without performing step S8.

Subsequently, the contract completion determination unit 354 in the storage node 3 accesses the blockchain 4 at regular intervals to search whether a contract document that includes the identification information H1 entered therein is registered in the blockchain 4 to determine whether the contract in the contract document has been completed (step S10, contract completion determination step). The interval at which the contract completion determination unit 354 accesses the blockchain 4 can be any interval, and may be the same as the interval at which a new block is added to the blockchain 4. In this embodiment, the crypto currency for use in the smart contract is Bitcoin; thus, the contract completion determination unit 354 accesses the blockchain 4 about every 10 minutes.

In step S5, the contract document uploaded together with the catalog in the contract document release server S is released to all nodes that are accessible to the contract document release server S, as described above. Here, it is assumed that the user of the second node 2, among these nodes, browsed the catalog and contract document, and wished to buy the personal data D1.

In this case, for example, in response to the user's operation via the input unit 21, the contract document selection unit 251 in the second node 2 selects the released contract document, and downloads the contract document in the second node 2 (step S11, contract document selection step). Downloading the contract document, however, is not essential.

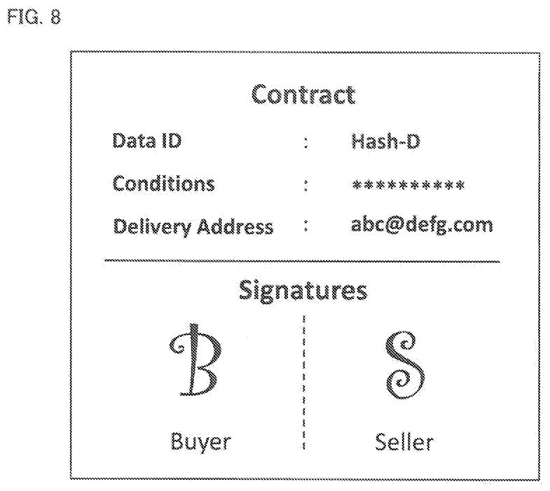

Subsequently, the address entry unit 252 in the second node 2 enters the data-receiving address of the second node 2 in the address area of the selected contract document (step S12, address entry step), and the signature unit 253 signs the contract document (step S13, signature step). This completes a contract document in which the data-receiving address of the second node 2 (abc@defg.com) is entered in the address entry space of the contract document, and the electronic signature of the buyer of data is placed in the signature space for the buyer (Buyer) as shown in FIG. 8.

Subsequently, the registration unit 254 in the second node 2 registers in the blockchain 4 the contract document that includes the data-receiving address entered by the address entry unit 252 and the signature placed by the signature unit 253 (step S14, registration step). Upon completion of the registration, a contract for providing the personal data D1 to the user of the second node 2 is completed.

Thereafter, the contract completion determination unit 354 in the storage node 3 accesses the blockchain 4. When confirming that the contract document is registered in the blockchain 4, the contract completion determination unit 354 determines that the contract has been completed (step S15).

In response to this step, the data transmission unit 355 in the storage node 3 transmits the personal data D1 stored in the storage unit 34 to the data-receiving address entered in the address area of the contract document (abc@defg.com) (step S16, data transmission step). This enables the second node 2 to receive the personal data D1. The data-receiving address can be any address; and may be, for example, an e-mail address, a storage area address, or a postal address.

### Summary of this Embodiment

As described above, although the personal data D1 is once stored in the storage node 3 from the first node 1 and sent to the second node 2 from the storage node 3, the contract document does not include the record of the storage location of the personal data D1; instead, the data-receiving address of the second node 2, which is the buyer, is described in the contract document. When the contract is completed, the personal data D1 is sent to the data-receiving address described in the contract document from the storage node 3.

Due to this configuration, even when the first node 1, which is the seller of the personal data D1, is offline, the second node 2, which is the buyer, can quickly receive the personal data D1 after completion of the contract. Additionally, because the storage location of the personal data D1 (storage node 3) is not described in the contract document registered in the blockchain 4, hacking attacks against the storage node 3 by a third party can be avoided. Thus, even when the seller is offline, a smart contract of confidential information can be executed safely and quickly.

### Second Embodiment

The second embodiment describes an embodiment in which an intermediary node for executing a smart contract more safely and smoothly is further provided. Note that members that have the same functions as those in the first embodiment are denoted by the same reference numerals, and the description thereof is omitted.

### System Configuration

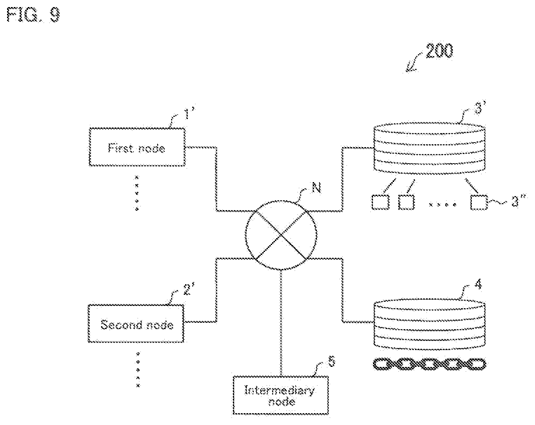

FIG. 9 schematically illustrates an information processing system 200 according to the second embodiment. The information processing system 200 includes a first node 1′, a second node 2′, a P2P storage 3′, a blockchain 4, and an intermediary node 5. The first node 1′, second node 2′, P2P storage 3′, blockchain 4, and intermediary node 5 are communicably connected to each other by wire or wirelessly via the communication network N.

The first node 1′ is an information processing device managed by a seller who owns data that is confidential information, and who wishes to sell the data. In the first node 1′, a first program P1′, described later, is installed. The configuration of the hardware of the first node 1′ is as described for the first node 1 according to the first embodiment.

The second node 2′ is an information processing device managed by a buyer who is to receive the data owned by the first node 1′. In the second node 2′, a second program P2′, described later, is installed. The configuration of the hardware of the second node 2′ is as described for the second node 2 according to the first embodiment.

The P2P storage 3′ is a storage jointly constructed by many and unspecified storage nodes 3″ that are connected via a P2P network. Because the stored data in the P2P storage 3′ is dispersed into the plurality of storage nodes 3″ and concealed, the individual storage nodes 3″ cannot access the entire data.

The intermediary node 5 is an information processing device managed by an intermediary agent who offers a smart contract execution service. In the intermediary node 5, an intermediary program P4, described later, is installed. In this embodiment, the first program P1′ installed in the first node 1, the second program P2′ installed in the second node 2, and the storage program P3 installed in the storage node 3″ are delivered from the intermediary node 5.

### Configuration of Each Node

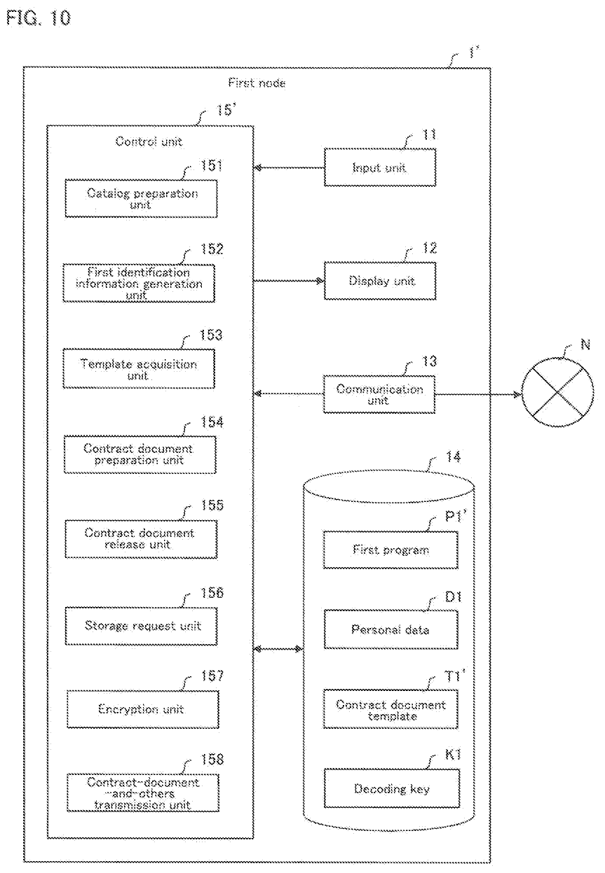

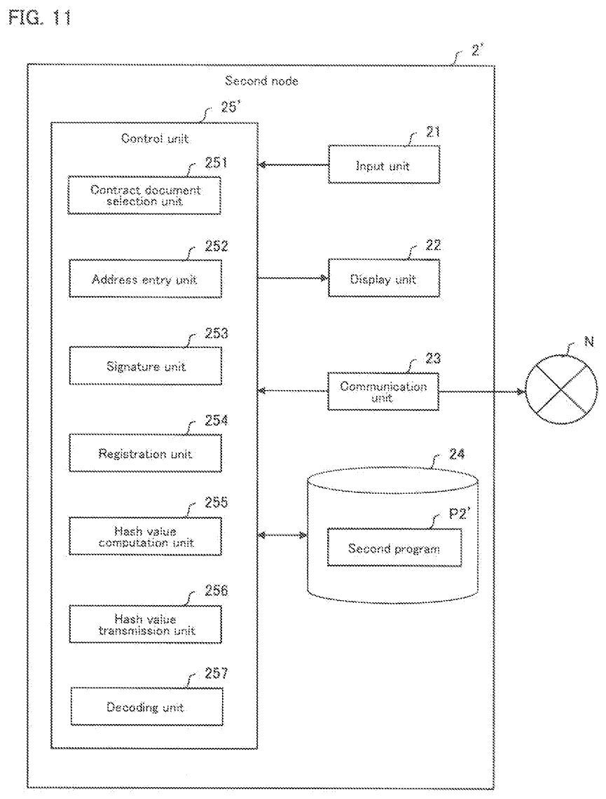

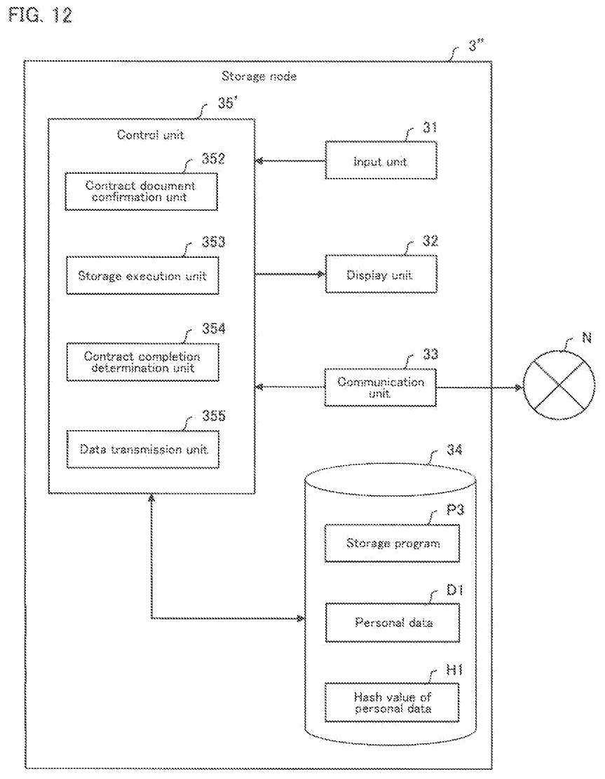

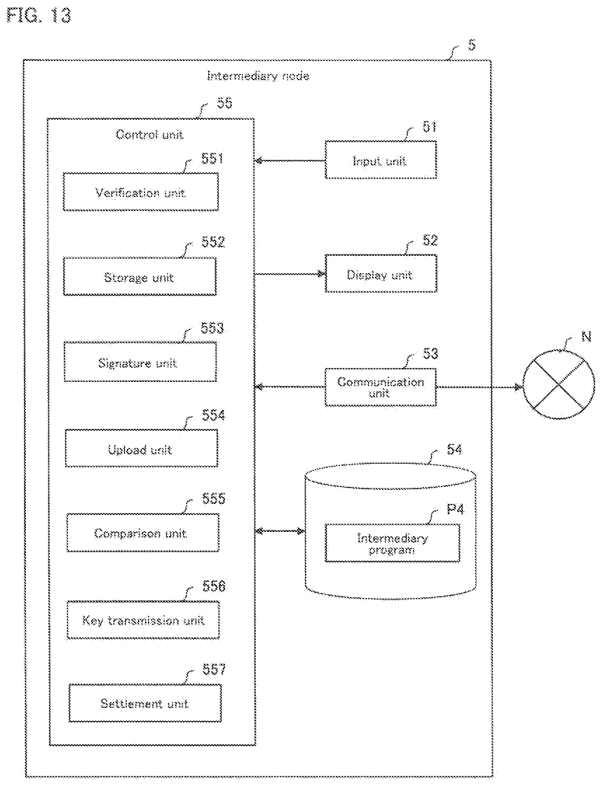

FIG. 10 is a functional block diagram illustrating the configuration of the first node 1′. FIG. 11 is a functional block diagram illustrating the configuration of the second node 2′. FIG. 12 is a functional block diagram illustrating the configuration of one of the storage nodes 3″ that jointly constitute the P2P storage 3′. FIG. 13 is a functional block diagram illustrating the configuration of the intermediary node 5.

As shown in FIG. 10, the first node 1′ includes an input unit 11, a display unit 12, a communication unit 13, a storage unit 14, and a control unit 15′. Specifically, the first node 1′ has the configuration of the first node 1 shown in FIG. 2, except that the control unit 15 is replaced with the control unit 15′.

The storage unit 14 stores a first program P1′, personal data D1, a template T1′, and a decoding key K1 according to this embodiment. The first program P1′ is a program for causing the first node 1′ to execute a part of the processing steps of a smart contract execution service in the information processing system 200. The personal data D1 is, as in the first embodiment, confidential information that the user of the first node 1′ wishes to sell. The template T1′ and the decoding key K1 will be described later.

The control unit 15′ includes the catalog preparation unit 151, the first identification information generation unit 152, the template acquisition unit 153, the contract document preparation unit 154, the contract document release unit 155, the storage request unit 156, an encryption unit 157, and a contract-document-and-others transmission unit 158. Specifically, the control unit 15′ has the configuration of the control unit 15 shown in FIG. 2, except that the encryption unit 157 and the contract-document-and-others transmission unit 158 are further provided. The function of these units will be described later.

As shown in FIG. 11, the second node 2′ includes the input unit 21, the display unit 22, the communication unit 23, the storage unit 24, and a control unit 25′. Specifically, the second node 2′ has the configuration of the second node 2 shown in FIG. 3, except that the control unit 25 is replaced with the control unit 25′.

The storage unit 24 stores the second program P2′ according to this embodiment. The second program P2′ is a program for causing the second node 2′ to execute a part of the processing steps of a smart contract execution service in the information processing system 200.

The control unit 25′ includes the contract document selection unit 251, the address entry unit 252, the signature unit 253, the registration unit 254, a hash value computation unit 255, a hash value transmission unit 256, and a decoding unit 257. The function of these units will be described later.

As shown in FIG. 12, the storage node 3″ includes the input unit 31, the display unit 32, the communication unit 33, the storage unit 34, and a control unit 35′. Specifically, the storage node 3″ has the configuration of the storage node 3 shown in FIG. 4, except that the control unit 35 is replaced with the control unit 35′.

The control unit 35′ includes the contract document confirmation unit 352, the storage execution unit 353, the contract completion determination unit 354, and the data transmission unit 355. Specifically, the control unit 35′ has the configuration of the control unit 35 shown in FIG. 4, except for the omission of the second identification information generation unit 351.

As shown in FIG. 13, the intermediary node 5 includes an input unit 51, a display unit 52, a communication unit 53, a storage unit 54, and a control unit 55. The input unit 51, the display unit 52, the communication unit 53, and the storage unit 54 may be respectively configured in the same manner as the input unit 11, the display unit 12, the communication unit 13, and the storage unit 14 in the first node 1 shown in FIG. 2.

The storage unit 54 stores an intermediary program P4 according to this embodiment. The intermediary program P4 is a program for causing the intermediary node 5 to execute a part of the processing steps of a smart contract execution service in the information processing system 200.

The control unit 55 is a functional block that is put into practice when the arithmetic processing unit, such as a CPU or MPU, provided in the intermediary node 5 retrieves the intermediary program P4 stored in the storage unit 54 into a main storage device, such as RAM, and executes the intermediary program P4. The control unit 55 includes a verification unit 551, a storage unit 552, a signature unit 553, an upload unit 554, a comparison unit 555, a key transmission unit 556, and a settlement unit 557. The function of these units will be described later.

### Processing Procedure

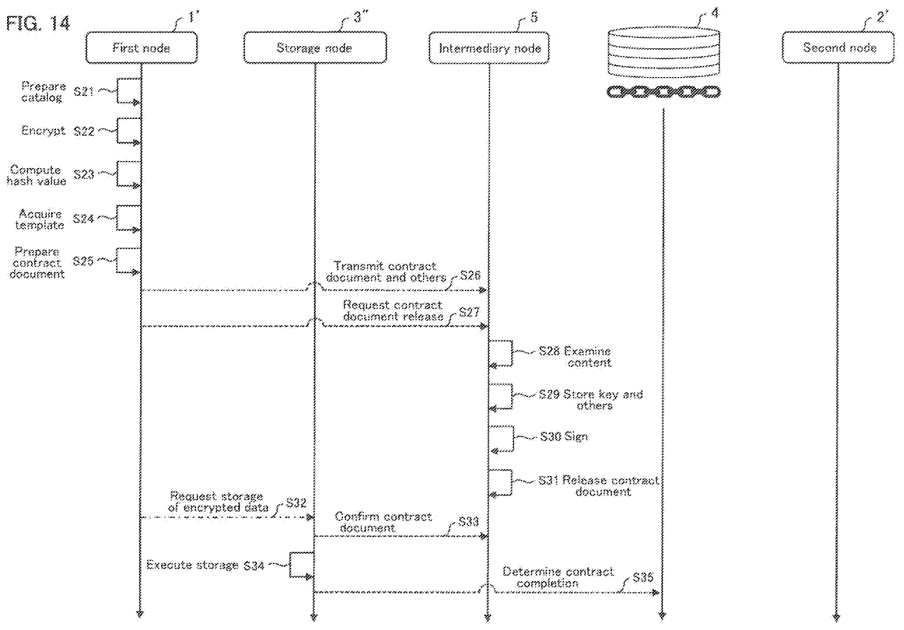

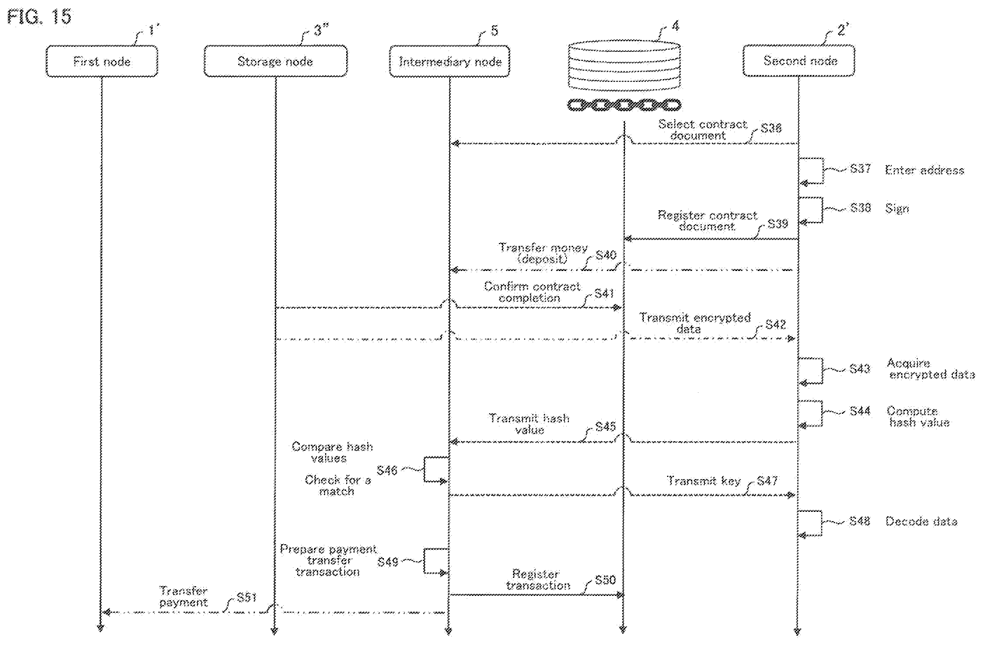

FIGS. 14 and 15 are a sequence chart illustrating the processing steps of a method for providing data by which personal data is provided from the first node 1 to the second node 2 in the information processing system 200. Regarding the arrows indicating the communication between nodes in FIGS. 14 and 15, the solid-line arrows indicate broadcasting. The dashed-line arrows indicate encrypted communication. The dash-dot-dash-line arrows indicate an anonymous encrypted communication whose sender is anonymized, and whose communication channel is encrypted. The dash-dot-dot-dash-line arrows indicate the flow of a crypto currency on the blockchain 4. The form of communication in each processing step is not limited to those described above.

In this embodiment, the main processing steps in FIGS. 14 and 15 are executed by the control unit 15′ in the first node 1′, the control unit 25′ in the second node 2′, the control units 35′ in the storage nodes 3″, and the control unit 55 in the intermediary node 5, which are respectively shown in FIGS. 10 to 13. The user may manually execute a part of the processing steps shown in FIGS. 14 and 15 via the input unit 11 in the first node 1′, the input unit 21 in the second node 2′, the input unit 31 in the storage node 3″, or the input unit 51 in the intermediary node 5.

First, in the first node 1′, the catalog preparation unit 151 prepares a catalog for describing the content of the personal data D1, which is confidential information (step S21). When the personal data D1 is a medical image, the catalog contains, for example, the user's gender, height, weight, and medical history, the date and time of photographing, and the type of format.

Subsequently, the encryption unit 157 in the first node 1′ encrypts the personal data D1 to prepare encrypted data (step S22). The decoding key K1 stored in the storage unit 14 is a key for decoding the encrypted data.

Subsequently, the first identification information generation unit 152 in the first node 1′ generates identification information for the personal data D1 (step S23, first identification information generation step). In this embodiment, the first identification information generation unit 152 calculates the hash value of the personal data D1 (Hash-D) to generate the hash value (Hash-D) as identification information, while calculating the hash value of the catalog (Hash-X) at the same time. Additionally, the first identification information generation unit 152 also calculates the hash value of the encrypted data (encryption hash value, Hash-E).

Subsequently, the template acquisition unit 153 in the first node 1′ acquires a template T1′ for a contract document for selling the personal data D1 (step S24, template acquisition step). The mode for acquisition of the template T1′ is as in the first embodiment.

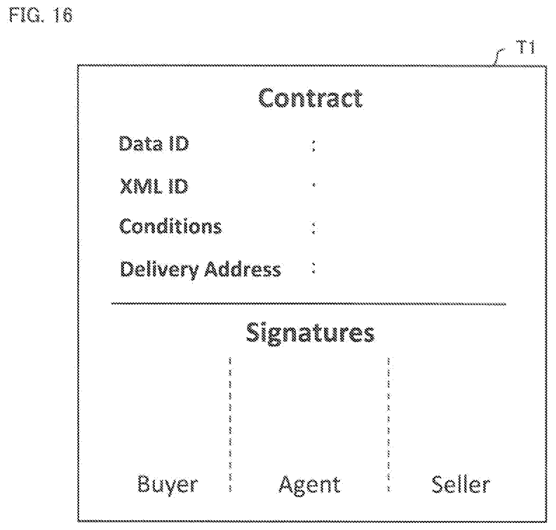

FIG. 16 shows an example of the template T1′. The template T1′ is provided with a space for entering the identification information (Data ID), the hash value of the catalog (XML ID), conditions under which data is provided (Conditions), a signature (Signatures), and a data-receiving address (Delivery Address). The space for signature includes a signature space for the seller of data (Seller), a signature space for the buyer of data (Buyer), and a signature space for the intermediary agent (Agent).

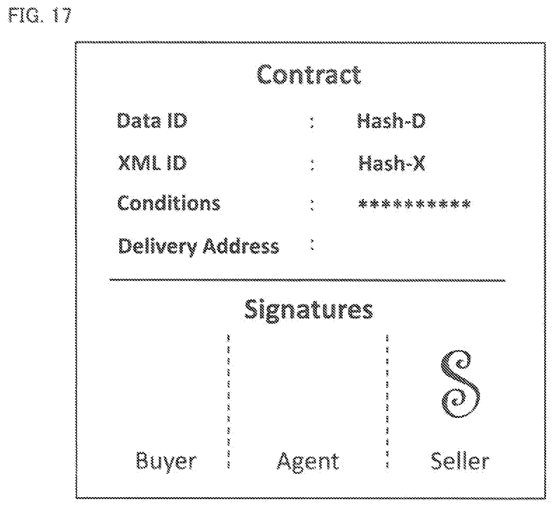

Refer back to FIG. 14. After completion of the acquisition of the template T1′, the contract document preparation unit 154 in the first node 1′ enters the identification information in the template T1′ and signs the template T1′, thereby preparing a contract document (step S25, contract document preparation step). FIG. 17 shows an example of a prepared contract document. As described above, the identification information is hash values (Hash-D of the personal data D1 and Hash-X of the catalog); thus, Hash-D and Hash-X are placed in the Data ID and XML ID, respectively. For the Conditions section, a condition such as the offer price of data is entered. In the signature space for the seller of data (Seller), an electronic signature is placed. The method for decoding concealed data that has reached the buyer is also described.

The space for a data-receiving address in the contract document is for entering the address of the buyer of data. Thus, the space is left blank at this stage.

Refer back to FIG. 14. After completion of the preparation of the contract document, the contract-document-and-others transmission unit 158 in the first node 1′ transmits the contract document to the intermediary node 5, together with the catalog, the decoding key K1, and the encryption hash value (Hash-E) (step S26). Then, in order to release the contract document to all of the nodes in the information processing system 200, the contract document release unit 155 in the first node 1′ requests the intermediary node 5 to release the contract document and catalog (step S27).

In response to the request, the verification unit 551 in the intermediary node 5 examines, for example, whether the personal data D1 that the first node 1′ is offering to sell is socially appropriate (e.g., whether any antisocial content is contained), on the basis of the contract document and catalog received from the first node 1′ (step S28). Step S28 may be skipped.

When the personal data D1 is determined to be appropriate, the storage unit 552 in the intermediary node 5 stores in the storage unit 54 the decoding key K1 and the encryption hash value (Hash-E) received from the first node 1′ (step S29).

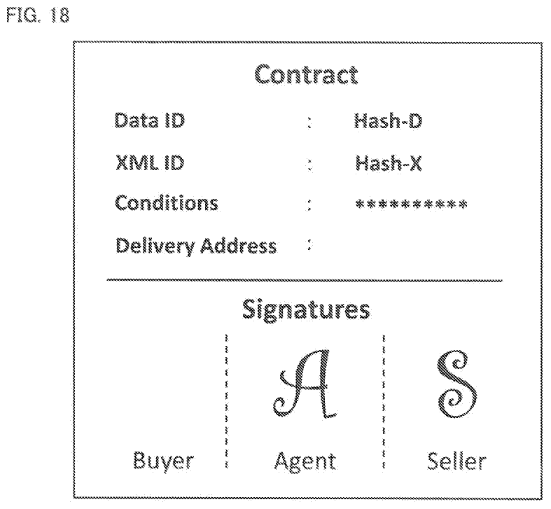

The signature unit 553 in the intermediary node 5 signs the contract document (step S30). This places an electronic signature on the signature space for the intermediary agent in the contract document as shown in FIG. 18. The order of step S29 and step S30 may be reversed.

Subsequently, the upload unit 554 in the intermediary node 5 uploads the contract document received from the first node 1′ on a predetermined contract document release server (e.g., a website operated by the intermediary agent), together with the catalog, thereby releasing the contract document (step S31, contract document release step).

In the first node 1′, the storage request unit 156 transmits the personal data D1 concealed through, for example, encryption and/or dispersion, together with the identification information (the hash value, Hash-D), to a group of storage nodes 3″ that jointly constitute the P2P storage 3′; and requests the group of storage nodes 3″ to individually store and conceal the dispersed item of the personal data D1 (step S32, storage request step). This request may contain access information for the contract document uploaded in step S31. Specifically, in this embodiment, unlike in the first embodiment, the storage request unit 156 transmits concealed data, instead of the personal data D1, to the group of storage nodes 3″; and requests the storage nodes 3″ to individually store and conceal the dispersed item of the data.

Subsequently, when each of the storage nodes 3″ has received the request from the storage request unit 156 in the first node 1′, the contract document confirmation unit 352 accesses the contract document uploaded in step S31 and confirms that the contract document that includes the identification information entered therein is released (step S33) on the basis of the identification information received from the storage request unit 156. Step S33 may be skipped.

Thereafter, the storage execution unit 353 of each storage node 3″ stores the concealed data and identification information (hash value (Hash-D)=personal data (hash value H1)) received from the first node 1′ in their own storage unit 34 (step S34, storage execution step). Specifically, in this embodiment, unlike in the first embodiment, the storage execution unit 353 stores concealed data, instead of the personal data D1.

Subsequently, the contract completion determination unit 354 of each storage node 3″ accesses the blockchain 4 at regular intervals, and searches whether a contract document that includes the identification information is registered in the blockchain 4 to determine whether the contract in the contract document has been completed (step S35, contract completion determination step).

Here, it is assumed that the user of the second node 2′ browsed the contract document and catalog released in step S31, and wished to buy the personal data D1.

In this case, the contract document selection unit 251 in the second node 2′ selects the released contract document, for example, in response to the operation via the input unit 21 by the user, and downloads the contract document in the second node 2′ (step S36, contract document selection step). Note that downloading the contract document is not essential.

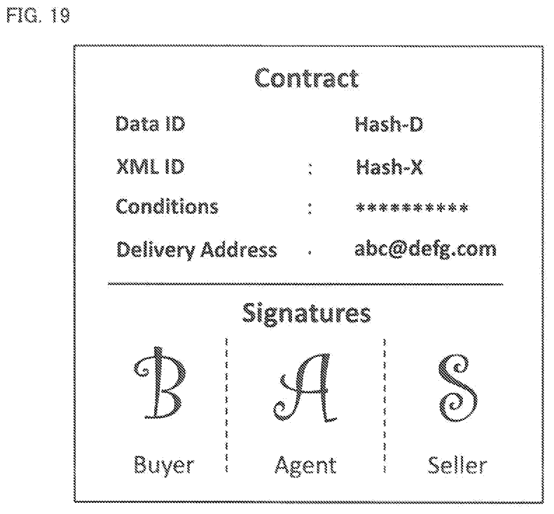

Subsequently, the address entry unit 252 in the second node 2′ enters the data-receiving address of the second node 2′ in the address area of the selected contract document (step S37, address entry step), and the signature unit 253 signs the contract document (step S38, signature step). This completes a contract document in which the data-receiving address of the second node 2′ (abc@defg.com) is entered in the address entry space in the contract document, and the electronic signature of the buyer of data is placed in the signature space for the buyer (Buyer) as shown in FIG. 19.

Subsequently, the registration unit 254 in the second node 2′ registers in the blockchain 4 the contract document that includes the data-receiving address entered by the address entry unit 252 and the signature placed by the signature unit 253 (step S39, registration step). After completion of the registration, a contract for selling the personal data D1 to the user of the second node 2′ is completed.

After completion of the contract, the payment for the personal data D1 is once deposited in the intermediary node 5 (S40). More specifically, the amount of payment for the personal data D1 together with an intermediary charge is transferred from the second node 2′ to the intermediary node 5.

Thereafter, the contract completion determination unit 354 of each storage node 3″ accesses the blockchain 4. When the contract completion determination unit 354 has confirmed that the contract document is registered in the blockchain 4, the contract completion determination unit 354 determines that the contract in the contract document has been completed (step S41).

In response to this step, the data transmission unit 355 in each storage node 3″ that has determined the completion of the contract in the contract document transmits the concealed data stored in the storage unit 34 (step S42, data transmission step) to the data-receiving address (abc@defg.com) entered in the address area of the contract document. Specifically, in this embodiment, unlike in the first embodiment, each data transmission unit 355 transmits concealed data, instead of the personal data D1, to the second node 2′. Because of this step, the second node 2′ receives a set of the concealed data and combines the set of the concealed data, thereby acquiring encrypted data (step S43).

Subsequently, the second node 2′ and the intermediary node 5 perform the following processing steps to decode the encrypted data and obtain the personal data D1.

First, in the second node 2′, the hash value computation unit 255 calculates an encryption hash value (Hash-E′), which is a hash value of the encrypted data received from the storage nodes 3″ (step S44). Second, the hash value transmission unit 256 transmits the encryption hash value (Hash-E′) calculated by the hash value computation unit 255 to the intermediary node 5 (step S45).

In response to this step, the comparison unit 555 in the intermediary node 5 compares the encryption hash value (Hash-E′) received from the hash value transmission unit 256 with the encryption hash value (Hash-E) stored in the storage unit 54 (step S46). When these two encryption hash values (Hash-E, Hash-E′) compared by the comparison unit 555 match each other, the key transmission unit 556 transmits the decoding key K1 stored in the storage unit 54 to the second node 2′ (step S47).

In the second node 2′, the decoding unit 257 decodes the encrypted data acquired in step S43 by using the decoding key K1 received from the intermediary node 5 (step S48). Because of this step, the second node 2′ can acquire the personal data D1, which has been decoded from the encrypted data.

If the second node 2′ cannot acquire the personal data D1 due to some problem, some measures can be taken; for example, the second node 2′ can request the intermediary node 5 to refund the deposited payment.

After a predetermined period of time has passed from the transmission of the decoding key K1 to the second node 2′ by the key transmission unit 556, for example, without a refund request from the second node 2′, the settlement unit 557 in the intermediary node 5 performs a settlement process (steps S49 to S51). Specifically, the settlement unit 557 prepares a transaction for sending the payment to the first node 1′, which is the provider of the personal data D1 (step S49), and registers the transaction in the blockchain 4 (step S50). This step allows the payment to be sent to the first node 1′ (step S51).

### Summary of this Embodiment

In this embodiment, encrypted data prepared by encrypting the personal data D1 is once transferred from the first node 1′ to a group of storage nodes 3″ that jointly constitute the P2P storage 3′ such that the encrypted data is dispersed, concealed, and stored in the individual storage nodes 3″; and then sent from the group of the storage nodes 3″ to the second node 2′. In the contract document, the data-receiving address of the second node 2′, instead of the storage location of the encrypted data, is described. When a contract has been completed, the encrypted data is sent to the data-receiving address described in the contract document from the group of the storage nodes 3″. Thus, even when the first node 1′ is offline, the encrypted data is quickly transmitted to the second node 2′ after completion of the contract. Additionally, because the storage location of the encrypted data is not described in the contract document registered in the blockchain 4, hacking attacks against the storage nodes 3″ by a third party can be avoided.

Additionally, because the personal data D1 is dispersed, concealed, and stored in a plurality of the storage nodes 3″, the individual storage nodes 3″ cannot see the personal data D1. This reduces the risk of leaking the personal data D1 to a third party. The use of anonymous encrypted communication in various communications can further increase the confidentiality of the location of the first node 1 and the location of the group of the storage nodes 3″, which is the storage location of the dispersed and concealed personal data D1.

When the intermediary node 5 stores the decoding key for decoding the encrypted data and the hash value of the encrypted data, and the second node 2′ has received the encrypted data and has transmitted a hash value of the encrypted data to the intermediary node 5, a decoding key is provided to the second node 2′ on the condition that the intermediary node 5 has confirmed that the stored hash value matches the hash value received from the second node 2′. In this embodiment, as described above, the personal data D1 is once encrypted, and the second node 2′ that has received the encrypted data receives a decoding key on a predetermined condition. Thus, this embodiment can prevent personal data D1 from leaking to a third party more reliably than the first embodiment.

### Additional Notes

Although two embodiments of the present invention are described above, the present invention is not limited to these embodiments, and various modifications may be made without departing from the spirit and principal concept of the invention. The technical scope of the present invention also includes, for example, an embodiment formed by suitably combining technical means disclosed in each embodiment.

For example, in the first embodiment, the storage request unit 156 may transmit the identification information together with the personal data D1 to the storage node 3, and the storage node 3 may have a configuration not to generate identification information without having the second identification information generation unit 351. In the second embodiment, the storage request unit 156 may not transmit identification information to the storage nodes 3″, and the storage nodes 3″ may have a configuration to generate identification information of the data concealed by the second identification information generation unit 351.

In these embodiments described above, although the information processing system is a platform using the blockchain technique, the present invention is not limited to these cases. The information processing system may be a typical server-client system. In this case, the contract document is registered on a database provided to a server etc. instead of the blockchain.

### DESCRIPTION OF THE REFERENCE NUMERALS

1 first node
1′ first node
2 second node
2′ second node
3 storage node
3′ P2P storage
3″ storage node
4 blockchain
5 intermediary node
11 input unit
12 display unit
13 communication unit
14 storage unit
15 control unit
15′ control unit
151 catalog preparation unit
152 first identification information generation unit
153 template acquisition unit
154 contract document preparation unit
155 contract document release unit
156 storage request unit
157 encryption unit
158 contract-document-and-others transmission unit
21 input unit
22 display unit
23 communication unit
24 storage unit
25 control unit
25′ control unit
251 contract document selection unit
252 address entry unit
253 signature unit
254 registration unit
255 hash value computation unit
256 hash value transmission unit
257 decoding unit
31 input unit
32 display unit
33 communication unit
34 storage unit
35 control unit
351 second identification information generation unit
352 contract document confirmation unit
353 storage execution unit
354 contract completion determination unit
355 data transmission unit
51 input unit
52 display unit
53 communication unit
54 storage unit
55 control unit
551 verification unit
552 storage unit
553 signature unit
554 upload unit
555 comparison unit
556 key transmission unit
557 settlement unit
100 information processing system
200 information processing system
D1 personal data
H1 personal data hash value
K1 decoding key
N communication network
P1 first program
P1′ first program
P2 second program
P2′ second program
P3 storage program
P4 intermediary program
S contract document release server
T1 template
T1′ template

1. An information processing system comprising a first node that stores data, a second node that receives the data from the first node, at least one storage node, and a database, wherein the first node comprises
a first identification information generation unit that generates identification information of the data,
a template acquisition unit that acquires a template for a contract document for the first node to provide the data,
a contract document preparation unit that enters the identification information in the template and signs the template to prepare a contract document,
a contract document release unit that releases the contract document to the second node, and
a storage request unit that transmits the data to the at least one storage node and requests the at least one storage node to store the data,
wherein the template is provided with an address area in which a data-receiving address of a node that wishes to obtain the data is entered,
the second node comprises
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit,
the at least one storage node comprises
a second identification information generation unit that generates identification information of the data when the at least one storage node has received the request from the storage request unit,
a storage execution unit that stores the data together with the identification information,
a contract completion determination unit that searches whether the contract document that includes the identification information entered therein has been registered in the database to determine whether a contract in the contract document has been completed, and
a data transmission unit that transmits the stored data to the data-receiving address entered in the address area of the contract document when the contract is determined to have been completed.

2. An information processing system comprising a first node that stores data, a second node that receives the data from the first node, at least one storage node, and a database, wherein the first node comprises
a first identification information generation unit that generates identification information of the data,
a template acquisition unit that acquires a template for a contract document for the first node to provide the data,
a contract document preparation unit that enters the identification information in the template and signs the template to prepare a contract document,
a contract document release unit that releases the contract document to the second node, and
a storage request unit that transmits the data together with the identification information to the at least one storage node and requests the at least one storage node to store the data,
wherein the template is provided with an address area in which a data-receiving address of a node that wishes to obtain the data is entered,
the second node comprises
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit,
the at least one storage node comprises
a storage execution unit that stores the data together with the identification information when the at least one storage node has received the request from the storage request unit,
a contract completion determination unit that searches whether the contract document that includes the identification information entered therein has been registered in the database to determine whether a contract in the contract document has been completed, and
a data transmission unit that transmits the stored data to the data-receiving address entered in the address area of the contract document when the contract is determined to have been completed.

3. The information processing system according to claim 1, further comprising an intermediary node,
wherein the first node further comprises
an encryption unit that encrypts the data to prepare an encrypted data, and
a contract-document-and-others transmission unit that transmits the contract document prepared by the contract document preparation unit and a decoding key for decoding the encrypted data to the intermediary node,
wherein the identification information is a hash value of the data,
the first identification information generation unit further calculates an encryption hash value that is a hash value of the encrypted data,
the contract-document-and-others transmission unit further transmits the encryption hash value to the intermediary node,
the storage request unit transmits the encrypted data instead of the data to the at least one storage node, and requests the at least one storage node to store the encrypted data;
in the at least one storage node, the storage execution unit stores the encrypted data instead of the data, the data transmission unit transmits the encrypted data instead of the data;
the second node comprises
a hash value computation unit that calculates an encryption hash value that is a hash value of the encrypted data received from the at least one storage node, and
a hash value transmission unit that transmits the encryption hash value calculated by the hash value computation unit to the intermediary node; and
the intermediary node comprises
a storage unit that stores the decoding key and the encryption hash value that have been received from the contract-document-and-others transmission unit,
a comparison unit that compares the encryption hash value received from the hash value transmission unit with the stored encryption hash value, and
a key transmission unit that transmits the stored decoding key to the second node when the encryption hash values compared by the comparison unit match to each other.

4. The information processing system according to claim 1, wherein the storage nodes jointly construct a P2P storage.

5. The information processing system according to claim 1, wherein the database is a blockchain.

6. A method for providing data from a first node to a second node in an information processing system that comprises the first node, the second node, at least one storage node, and a database, the method comprising
a first identification information generation step of generating identification information of the data in the first node,
a template acquisition step of acquiring in the first node a template for a contract document for the first node to provide the data, the template being provided with an address area in which a data-receiving address of a node that wishes to obtain the data is entered,
a contract document preparation step of entering the identification information in the template and signing the template in the first node to prepare a contract document,
a contract document release step of releasing the contract document to the second node,
a storage request step of transmitting the data from the first node to the at least one storage node and requesting the at least one storage node to store the data,
a second identification information generation step of generating identification information of the data when the at least one storage node has received the request of the storage request step,
a storage execution step of storing the data together with the identification information,
a contract completion determination step of searching whether the contract document that includes the identification information entered therein has been registered in the database to determine whether a contract in the contract document has been completed in the at least one storage node,
a contract document selection step of selecting the released contract document in the second node,
an address entry step of entering a data-receiving address of the second node in the address area of the selected contract document in the second node,
a signature step of signing the selected contract document in the second node,
a registration step of registering in the database the contract document that includes the data-receiving address entered in the address entry step and a signature placed in the signature step, and
a data transmission step of transmitting the stored data in the at least one storage node to the data-receiving address that has been entered in the address area of the contract document when the contract is determined to have been completed in the contract completion determination step.

7. A method for providing data from a first node to a second node in an information processing system that comprises the first node, the second node, at least one storage node, and a database, the method comprising
a first identification information generation step of generating identification information of the data in the first node,
a template acquisition step of acquiring in the first node a template for a contract document for the first node to provide the data, the template being provided with an address area in which a data-receiving address of a node that wishes to obtain the data is entered,
a contract document preparation step of entering the identification information in the template and signing the template in the first node to prepare a contract document,
a contract document release step of releasing the contract document to the second node,
a storage request step of transmitting the data together with the identification information from the first node to the at least one storage node and requesting the at least one storage node to store the data,
a storage execution step of storing the data together with the identification information when the at least one storage node has received the request of the storage request step,
a contract completion determination step of searching whether the contract document that includes the identification information entered therein has been registered in the database to determine whether a contract in the contract document has been completed in the at least one storage node,
a contract document selection step of selecting the released contract document in the second node,
an address entry step of entering a data-receiving address of the second node in the address area of the selected contract document in the second node,
a signature step of signing the selected contract document in the second node,
a registration step of registering in the database the contract document that includes the data-receiving address entered in the address entry step and a signature placed in the signature step, and
a data transmission step of transmitting the stored data from the at least one storage node to the data-receiving address that has been entered in the address area of the contract document when the contract is determined to have been completed in the contract completion determination step.

8. The method for providing data according to claim 6, wherein the database is a blockchain.

9. A method for building an information processing system that comprises a first node that stores data, a second node that receives the data from the first node, at least one storage node, and a database, the method comprising
a step of delivering to the first node a program for causing a computer to operate as
a first identification information generation unit that generates identification information of the data,
a template acquisition unit that acquires a template for a contract document for the first node to provide the data, the template being provided with an address area in which a data-receiving address of a node that wishes to obtain the data is entered,
a contract document preparation unit that enters the identification information in the template and signs the template to prepare a contract document,
a contract document release unit that releases the contract document to the second node, and
a storage request unit that transmits the data to the at least one storage node and requests the at least one storage node to store the data,
a step of delivering to the second node a program for causing a computer to operate as
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit, and
a step of delivering to the at least one storage node a program for causing a computer to operate as
a second identification information generation unit that generates identification information of the data when having received the request from the storage request unit,
a storage execution unit that stores the data together with the identification information,
a contract completion determination unit that searches whether the contract document that includes the identification information entered therein has been registered in the database to determine whether a contract in the contract document has been completed, and
a data transmission unit that transmits the stored data to the data-receiving address entered in the address area of the contract document when the contract is determined to have been completed.

10. A method for building an information processing system that comprises a first node that stores data, a second node that receives the data from the first node, at least one storage node, and a database, the method comprising
a step of delivering to the first node a program for causing a computer to operate as
a first identification information generation unit that generates identification information of the data,
a template acquisition unit that acquires a template for a contract document for the first node to provide the data, the template being provided with an address area in which a data-receiving address of a node that wishes to obtain the data is entered,
a contract document preparation unit that enters the identification information in the template and signs the template to prepare a contract document,
a contract document release unit that releases the contract document to the second node, and
a storage request unit that transmits the data to the at least one storage node together with the identification information and requests the at least one storage node to store the data,
a step of delivering to the second node a program for causing a computer to operate as
a contract document selection unit that selects the released contract document,
an address entry unit that enters a data-receiving address of the second node in the address area of the selected contract document,
a signature unit that signs the selected contract document, and
a registration unit that registers in the database the contract document that includes the data-receiving address entered by the address entry unit and a signature placed by the signature unit, and
a step of delivering to the at least one storage node a program for causing a computer to operate as
a storage execution unit that stores the data together with the identification information when having received the request from the storage request unit,
a contract completion determination unit that searches whether the contract document that includes the identification information entered therein is registered in the database to determine whether a contract in the contract document has been completed, and
a data transmission unit that transmits the stored data to the data-receiving address entered in the address area of the contract document when the contract is determined to have been completed.

11. The method for building an information processing system according to claim 9, wherein the database is a blockchain.
